(19) United States
(12) Patent Application Publication
(10) Pub. No.: US 2003/0071461 A1
(43) Pub. Date: Apr. 17, 2003

(54) Tube connector

(76) Inventors: Michael T. Roberts, Thousand Oaks, CA (US); Mark T. Noel, Thousand Oaks, CA (US)

Correspondence Address: CHRISTIE, PARKER & HALE, LLP, P.O. BOX 7068, PASADENA, CA, 91109-7068, US

(21) Appl. No.: 10/269,753

(22) Filed: Oct. 11, 2002

Related U.S. Application Data
(60) Provisional application No. 60/328,219, filed on Oct. 11, 2001.

(51) Int. Cl. F16L 17/00

(52) U.S. Cl. 285/354; 285/339; 285/341

(57) ABSTRACT

A tube connecting system and apparatus directed to connecting a tube to a cylinder are provided. A system includes a first sleeve, a second sleeve, a radially compressible ring, and a radially compressible tube. The tube fits radially inside of the ring and the first and second sleeves. As the first and second sleeves are coupled and brought closer together, inner surfaces of the sleeves exert a radial force onto the ring, causing it to radially compress onto the tube, which compresses in response. Contact surfaces may be added to one or both of the sleeves for axially compressing the tube.

### CROSS-REFERENCE TO RELATED APPLICATION(S)

This application claims priority to U.S. provisional application No. 60/328,219, filed on Oct. 11, 2001, the contents of which are fully incorporated herein by reference.

### FIELD OF THE INVENTION

The present invention relates to connectors, more particularly to tube connectors.

### BACKGROUND OF THE INVENTION

Transport of materials such as liquids, gases, and solids frequently requires connection of tubes to fittings, pipes, or other hollow cylinders. If the connection is loose or allows leaking of the material, the transport can quickly become inefficient and the leaks can cause damage in the surrounding environment. This problem is prevalent in high pressure hose or tube, such as automobile radiator hose, connections. This problem is also especially dangerous in connections in lines or tubes used to transport hazardous or flammable liquids, such as, for example, fuel lines.

A need, therefore, exists in the art for a connector that provides a fluid tight connection. A further need exists for a connector that is simple and inexpensive to manufacture, or can be easily installed or uninstalled.

### SUMMARY OF THE INVENTION

The present invention is directed to a system and apparatus for connecting a tube. In one exemplary embodiment, a tube connection system includes a first sleeve coupled to a second sleeve. The sleeves surround a ring which sits axially between a sloped inner surface of the first sleeve and an opposing sloped inner surface of the second sleeve. The ring surrounds a radially compressible tube. For the purposes of this disclosure, “radially compressible” is defined as having at least some capability of compressing its diameter in response to inward radial forces. A “tube” for purposes of this disclosure, is any substantially hollow cylindrical object, such as, for example, a pipe, a rubber hose, etc.

As the two sleeves are coupled together, the ring is compressed onto the tube by the first and second sloped inside surfaces exerting a radial force on the tube, which radially compresses in response. In one exemplary embodiment, a cylinder is fitted into the tube. A “cylinder” for purposes of this disclosure is defined as any solid or hollow substantially cylindrical object, such as, for example, a ring or a pipe. The cylinder can be rigid or compressible. The tube then radially compresses in response to the radial force of the ring onto the cylinder to form a connection. In essence, the ring clamps the tube onto the cylinder.

In another embodiment, the tube is also axially compressible. For purposes of this disclosure, “axially compressible” is defined as having at least some capability of compressing in response to inward axial forces. In this embodiment, at least one of the first and second sleeves includes a contact surface, e.g., an inwardly projecting ledge or gripping element, for contacting the tube. The contact surface can grip onto a portion of the tube, thereby axially compressing the tube between the contact surface and the portion of the tube clamped by the ring. Consequently, the portion of the tube between the contact surface and the ring can axially compress and radially expand when the sleeves are brought sufficiently close forming a seal against the cylinder. Another exemplary embodiment includes at least one contact surface on each of the sleeves. The contact surfaces grip a portion of the tube for axially compressing the tube at two locations.

In a further embodiment, an end of the cylinder is located axially between the contact surface and the ring. The end can have the same or a different diameter than the rest of the cylinder. The cylinder may also include an annular lip projecting radially outward from the cylinder. Thus, the lip may further radially compress the tube to form a better seal.

In a further exemplary embodiment, one of the contact surfaces of one of the sleeves compresses a portion of the tube to a diameter smaller than the diameter of the cylinder's end.

In still yet another exemplary embodiment, one sleeve has a contact surface in the form of a ledge that extends adjacent to an end of the tube for axially compressing the end of the tube.

### BRIEF DESCRIPTION OF THE DRAWINGS

One or more of these features and advantages will be better understood by reference to the following detailed description when considered in conjunction with the accompanying drawings wherein:

FIG. 1 is a partial cross-sectional view of a device according to one exemplary embodiment of the invention; and

FIG. 2 is a partial cross-sectional view of a system according to another exemplary embodiment of the invention.

### DETAILED DESCRIPTION OF THE INVENTION

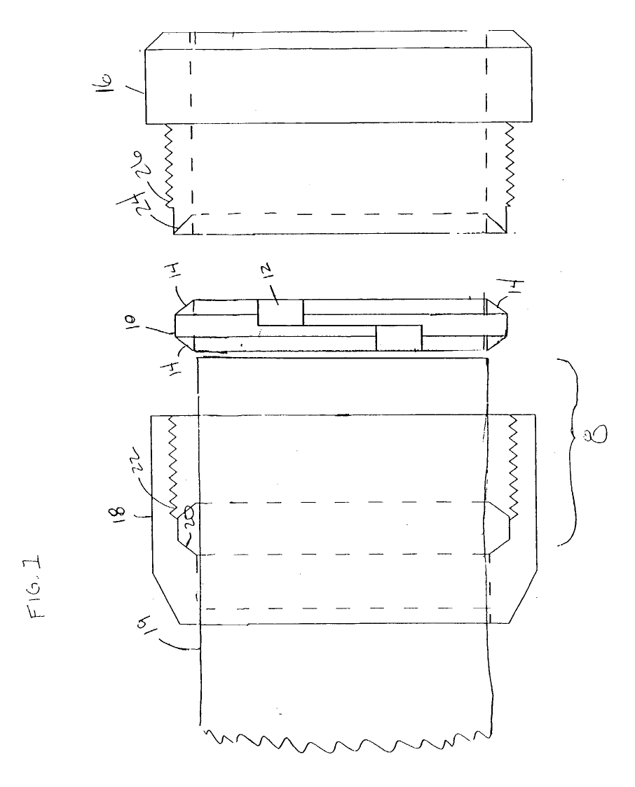

The present invention is directed to a tube connecting system and apparatus. In an exemplary embodiment shown in FIG. 1, the system includes a split sealing ring 10 having tapered opposed outer surfaces 14, a first sleeve 16, a second sleeve 18, and a radially compressible tube 19. The sleeves 16, 18 may be manufactured from any rigid material, such as, for example, aluminum, Teflon™, Delrin™, or nylon. In the exemplary embodiment the split ring has staggered gaps 12 defining the split and is made from a metallic material such as aluminum. In an alternate exemplary embodiment, the split ring has a single gap across the width of the ring.

The ring 10 surrounds (i.e., is fitted around) the tube 19 at an overlapping area 8 where a cylinder (not shown) can be inserted into the tube 19. The ring 10 sits within the second sleeve 18 in a sloped seat 20 formed on an inner surface of the second sleeve 18 adjacent to threads 22 formed on the second sleeve 18 inner surface. The first sleeve 16 has a sloped seat 24 formed on an inner surface of the first sleeve 20 adjacent to threads 26 formed on an outer surface of the first sleeve 16.

When the sleeves 16, 18 are threaded together, the sloped seats 20 and 24 are brought closer. The ring 10 is sandwiched between the sloped seats 20, 24, and the seats 20, 24 push against the tapered outer surfaces 14 of the ring 10 as the sleeves 16, 18 are threaded closer together, compressing the ring 10. In one embodiment, the slopes of the seats 20, 24 are similar or identical to the slope of their corresponding tapered ring surface 14, so that the ring surfaces 14 smoothly slide along the sloped seats 20, 24 as the two sleeves are threaded together. In one embodiment, the seats 20, 24 and ring surface 14 are inclined at an angle of around 60 degrees from the horizontal. Applicants have discovered that an incline of 60 degrees provides for smooth compressing operation of the ring as the sleeves are threaded together.

As the staggered gaps 12 of the ring 10 begin to close when the sleeves are threaded together, the ring 10 decreases in diameter, thereby clamping the tube against any member that is inserted in the tube as for example a cylinder (not shown) providing a tight high pressure seal against the cylinder.

Although the embodiment shown in FIG. 1 includes a sealing ring 10 with tapered opposed outer surfaces 14, the outer surface of the ring 10 can also be flat, rounded, or any surface that would allow the force from the tapered seats 20, 24 to radially compress the ring 10 when the sleeves 16, 18 are brought closer together. Although the sleeves 14, 16 are shown in FIG. 1 as threaded together, any other means of connecting the first and second sleeves 14, 16 may also be used.

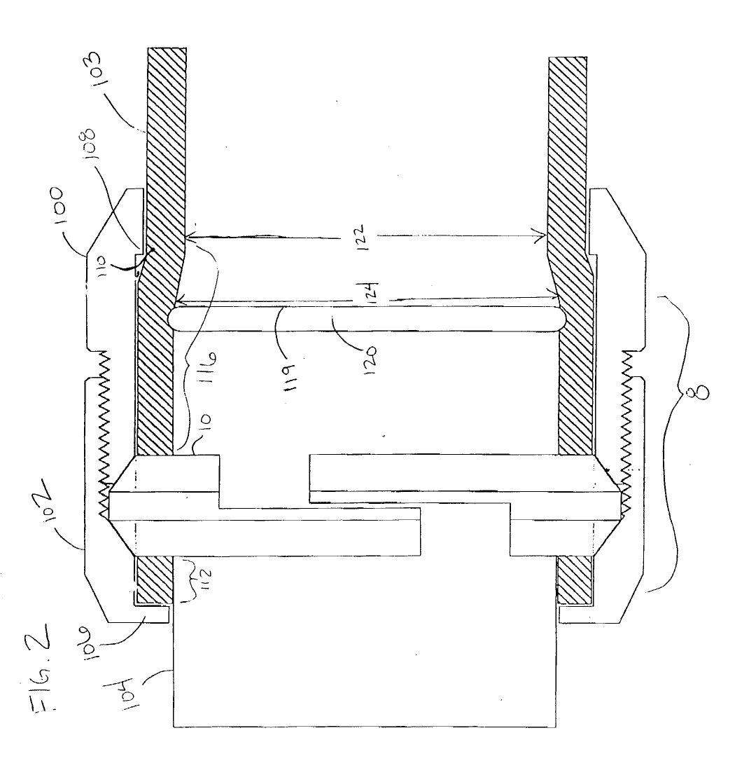

Referring to FIG. 2, an exemplary embodiment of a system according to the invention includes a first sleeve 100, a second sleeve 102, a split sealing ring 10, a radially and axially compressible tube 103 and a cylinder 104. The second sleeve 102 includes a contact surface 106 for gripping the tube 103. In this embodiment, the contact surface 106 projects radially inward toward the cylinder 104 and allows for the system to be self-positioning over the end of the tube 103. Although the embodiment shown in FIG. 2 shows the contact surface 106 as a ledge which partially encloses an end of the tube 103, any contact surface 106 capable of gripping a portion of the tube 103 can be used.

The first sleeve 100 also includes a contact surface 108 for contacting the tube 103. Although the contact surface 108 is shown as a ledge 108 projecting inward to radially compress the tube 103 at a point 110 where the tube 103 does not overlap the cylinder 104, any contact surface 108 capable of gripping the tube 103 can be used on or off of the overlapping portion 8.

Like the embodiment shown in FIG. 1, as the sleeves 100, 102 are threaded closer together, the ring 10 will radially compress onto the tube 103 and the tube 103 will radially compress onto the cylinder 104. Additionally, since the tube 103 in FIG. 2 is axially compressible, the contact surfaces axially compress the tube against the tube portion clamped by the ring. Consequently, the axially compressed tube portions expand forming further seals against the outer surface of the cylinder. For example, the end section 112 of the tube between the contact surface 106 and the ring 10 will axially compress and expand forming a seal against the cylinder outer surface. Likewise, the area 116 of the tube between the contact surface 108 and the ring 10 will axially compress and radially expand due to the friction or gripping of the contact surface 108, forming a seal against the cylinder outer surface. The effectiveness of this latter seal can be increased by projecting the contact surface 108 radially inward, as shown in FIG. 2. This projecting contact surface 108 also radially compresses the tube to a diameter 122 smaller than the diameter 124 of an end 119 of the cylinder 104. In another exemplary embodiment, an annular lip 120 is formed projecting radially from the cylinder 104 to further axially and radially compresses the tube. Thereby, this lip 120 can further increase the effectiveness of the seal. Consequently, with the exemplary embodiment shown in FIG. 2, further seals are formed between the tube and the outer surface of the cylinder in addition to the seal formed between the tube and the cylinder when clamped by the ring. Applicants have discovered that with the exemplary embodiment connector shown in FIG. 2, they can form high pressure tube connections that can withstand a gas or liquid, i.e. a fluid, pressure of over 100 psi.

Although the embodiment shown in FIG. 2 shows contact areas 106, 108 on both the first and second sleeves 100, 102, it is within the scope of the invention to include only a single contact area on either the first or the second sleeve 100, 102. Likewise, the structure described in relation to the first sleeve 100 can be applied to the second sleeve 102 and vice versa.

Another embodiment (not shown) also includes a second tube connector system located on the other end of the tube for connecting a cylinder to each end of the tube. This embodiment additionally includes a third sleeve coupled to a fourth sleeve, the sleeves radially surrounding a second ring. The second ring sits axially between a third and a fourth sloped inside surfaces on the third and fourth sleeves, respectively. The second ring radially surrounds the tube at the opposite end as the first ring. The second ring surrounds a second cylinder and radially compresses the tube around the second cylinder when the third and fourth sleeves are brought together. With this embodiment, the compressible tube is used to couple two cylinders.

As can be seen, the connector and system of the present invention provide for high pressure connections that are easy to form and re-form if necessary. The simplicity of mechanical structure and relatively few number of parts also decrease production costs and increase efficiency.

Although specific embodiments are disclosed herein, it is expected that persons skilled in the art can and will design alternative embodiments of the invention that are within the scope of the following claims either literally or under the Doctrine of Equivalents.

What is claimed is:

1. A tube connection system comprising:
a first sleeve having a first sloped inside surface;
a second sleeve coupled to the first sleeve, the second sleeve having a second sloped inside surface that opposes the first sloped inside surface;
a ring located radially inside of the first and second sleeves, and axially between the first and second sloped inside surfaces; and
a tube that is radially compressible and surrounded by the ring,
wherein when the first sleeve and second sleeve are brought together, the first and second sloped inside surfaces radially compress the ring, and the ring radially compresses the tube.

2. The tube connection system of claim 1, further comprising a first contact surface for contacting the tube, located on one of the first sleeve and the second sleeve.

3. The tube connection system of claim 2, wherein the first contact surface axially compresses a tube portion located between the first contact surface and the ring when the first and second sleeves are brought together.

4. The tube connection system of claim 3, wherein the first contact surface comprises a ledge, the ledge projecting radially inward.

5. The tube connection system of claim 3, further comprising a second contact surface for contacting the tube, located on the other of the first sleeve and the second sleeve.

6. The tube connection system of claim 5, wherein the second contact surface axially compresses a portion of the tube located between the second contact surface and the ring when the first and second sleeves are brought together.

7. The tube connection system of claim 5, wherein the second contact surface comprises a ledge, the ledge projecting radially inward and over an end of the tube.

8. The tube connection system of claim 1, further comprising a cylinder located radially inside a first end of the tube and surrounded by the ring, said cylinder being in contact with the tube when the ring is radially compressed.

9. The tube connection system of claim 8, further comprising an annular lip projecting radially outward from the cylinder.

10. The tube connection system of claim 9, further comprising:
a first contact surface contacting the tube and located on one of the first sleeve and the second sleeve; and
an end on the cylinder proximate to the first contact surface, wherein the tube is axially compressible.

11. The tube connection system of claim 10, wherein the end has an outer surface diameter greater than an outer surface diameter of the remaining portion of the tube.

12. The tube connection system of claim 10, wherein the first contact surface axially compresses a portion of the tube when the first and second sleeves are brought together.

13. The tube connection system of claim 12, further comprising a second contact surface located on the other of the first sleeve and the second sleeve, the second contact surface contacting the tube.

14. The tube connection system of claim 13, wherein the second contact surface axially compresses the tube when the first and second sleeves are brought together.

15. The tube connection system of claim 13, wherein the second contact surface comprises a ledge, the ledge projecting radially inward and at least partially enclosing an end of the tube.

16. The tube connection system of claim 10, wherein the first contact surface comprises a ledge, the ledge projecting radially inward.

17. The tube connection system of claim 16, wherein the ledge projects radially inward radially compressing the tube.

18. The tube connection system of claim 8, further comprising:
a third sleeve having a third sloped inside surface;
a fourth sleeve coupleable to the third sleeve, the fourth sleeve having a fourth sloped inside surface;
a second cylinder radially inside a second end of tube and at least one of the third sleeve and the fourth sleeve; and
a second ring surrounding the tube and the second cylinder, wherein when the third and fourth sleeves are brought together, the third and fourth sloped inside surfaces radially compress the second ring, and the second ring radially compresses the tube on the second cylinder.

19. The tube connecting system of claim 1, wherein the ring is a split ring.

20. The tube connecting system of claim 19, wherein the ring has staggered gaps.

21. A tube connecting apparatus comprising:
a first sleeve having a first sloped inside surface;
a second sleeve coupled to the first sleeve, the second sleeve having a second sloped inside surface that opposes the first sloped inside surface;
a compressible ring located radially inside of the first and second sleeves, and axially between the first and second sloped inside surfaces;
a first contact surface on the first sleeve, the first contact surface spaced from the first sloped inside surface and projecting radially inward; and
a second contact surface on the second sleeve, the second contact surface spaced from the second sloped inside surface and projecting radially inward.
